(19) United States
(12) Patent Application Publication
(10) Pub. No.: US 2014/0188801 A1
(43) Pub. Date: Jul. 3, 2014

(54) METHOD AND SYSTEM FOR INTELLIGENT LOAD BALANCING

(71) Applicant: VERIZON PATENT AND LICENSING INC., Basking Ridge, NJ (US)

(72) Inventors: Ramesh Babu RAMAKRISHNAN, Flower Mound, TX (US); Ramanujam ACHAN SETHURAMAN, Irving, TX (US); Felix R. TORRES-SANTIAGO, Irving, TX (US); Sanjay BASU, Plano, TX (US); Velamur Srinivasan SUDHARSAN, Flower Mound, TX (US); Vivek Gurumurthy, Irving, TX (US)

(73) Assignee: VERIZON PATENT AND LICENSING INC., Basking Ridge, NJ (US)

(21) Appl. No.: 13/729,460

(22) Filed: Dec. 28, 2012

(51) Int. Cl. G06F 17/30

(52) U.S. Cl. CPC G06F 17/30002
USPC 707/634

(57) ABSTRACT

An approach for providing intelligent load balancing between data centers is described. A load balancing platform monitors a replication delay associated with the replication of data between a first data center and a second data center, and determines to halt access to the data at the second data center if the delay satisfies a threshold delay value. The platform determines to allow access to the data at a second data center if the replication delay does not satisfy the threshold delay value.

### BACKGROUND INFORMATION

The maturity of electronic commerce has placed greater demands on data exchange. The efficient and rapid access of information across data centers in support of data centers is required by service providers to maintain their competitive edge. By way of example, cloud computing technologies such as virtualization have enabled service providers to offer various application hosting services to business and individual users. This has led to improved reliability and faster response times for clients accessing the offered services. However, greater workload mobility has also led to sub-optimal usage of computing resources. For example, a data center that is geographically proximate to users may be overloaded even when the workload could be distributed to other less geographically proximate data centers without significant changes in response times. From the user perspective, improper load balance negatively affects response times and ultimately the user experience.

Therefore, there is a need for an approach that provides intelligent load balancing among data centers.

### BRIEF DESCRIPTION OF THE DRAWINGS

Various embodiments are illustrated by way of example, and not by way of limitation, in the figures of the accompanying drawings in which like reference numerals refer to similar elements and in which:

FIG. 1 is a diagram of a system capable of providing intelligent load balancing, according to an embodiment;

FIG. 2 is a diagram of the components of a load balancing platform, according to an embodiment;

FIGS. 3A-3C are a flowchart for providing intelligent load balancing, according to an embodiment;

FIGS. 4A and 4B are ladder diagrams of a process for intelligent load balancing, according to an embodiment;

FIG. 5 is a diagram of a computer system that can be used to implement various embodiments; and

FIG. 6 is a diagram of a chip set that can be used to implement an embodiment of the invention.

### DESCRIPTION OF THE PREFERRED EMBODIMENT

An apparatus, method and software for intelligent load balancing are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

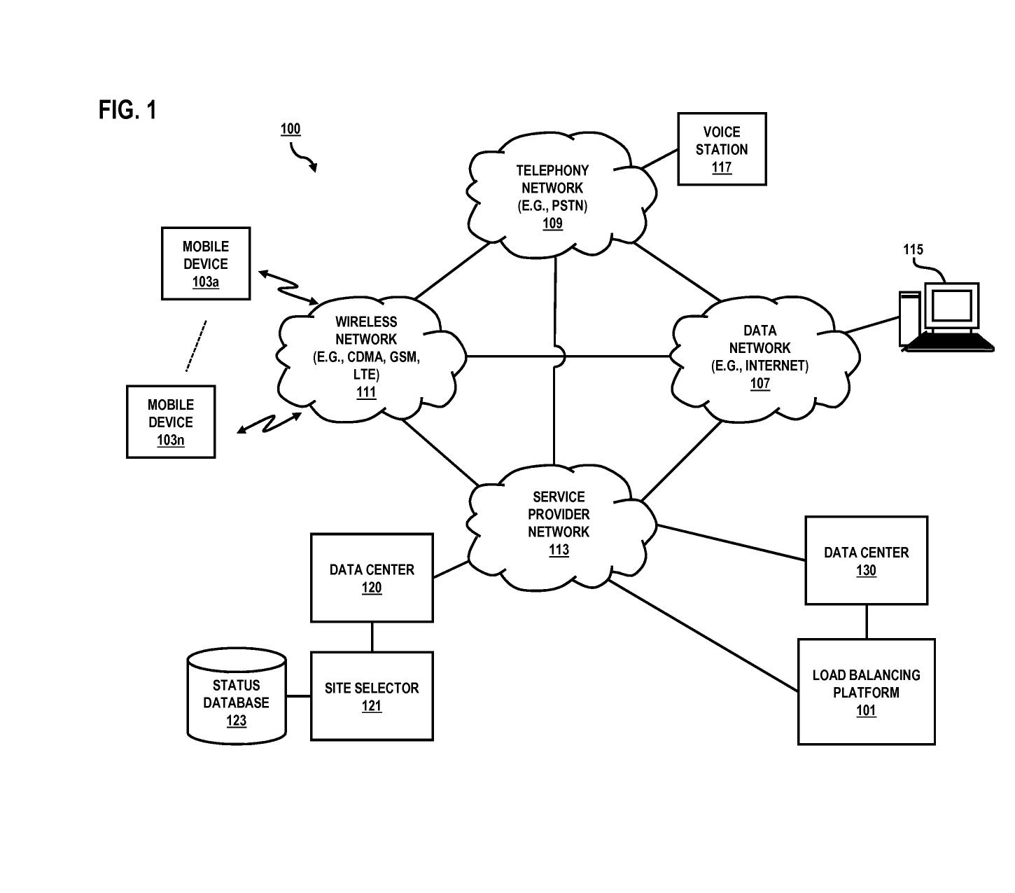

FIG. 1 is a diagram of a system capable of providing intelligent load balancing, according to an embodiment. For the purpose of illustration, the system 100 employs a load balancing platform 101 that is configured to provide intelligent load balancing between data centers 120 and 130. Caching and mirroring content at these data centers allows the service provider to place the content “closer” to the user. In this way, the user can retrieve multimedia data from the nearest duplicate server, which yields better performance (e.g., user experience). For example, service requests can be routed on the basis of various considerations, including geographic distance, to the data center that can provide the best response time. Each of the data centers 120, 130 may house one or more servers (e.g., server farm) to store information that supports the services of the service provider. Also, the data centers 120, 130 can maintain a database management system to control and manage access and storage of data. As will be further detailed, load balancing platform 101 manages the workload by redirecting traffic from one data center to another based on, for instance, data replication delay (or lag) and/or other factors (e.g., resource availability, bandwidth allocations/resources, network performance, etc.).

In certain embodiments, data centers 120 and 130 are data centers associated with a service provider. As used herein, data center refers to computing, data storage, and computer networking infrastructure operated and maintained by the service provider at a particular geographical location. While specific reference will be made thereto, it is contemplated that a data center may embody many forms and include multiple and/or alternative components and facilities. For example, a data center may be accessed by a corporate intranet or by a call center.

As shown, load balancing platform 101 may be a part of or connected to data center 130. Platform 101 may also be a standalone system that serves multiple data centers, including data centers 120, 130. The intelligent load balancing process of platform 101, in one embodiment, supports one or more services of the service provider and involves the routing of service requests received at data center 130. By way of example, the services include provisioning and billing of telecommunication services. In this embodiment, platform 101 communicates with each of the data centers 120 and 130 over the service provider network 113. The service requests may, for instance, be initiated by users (or subscribers) via one or more user devices (e.g., mobile devices 103 (or mobile devices 103a-103n), computing device 115) over one or more networks (e.g., data network 107, telephony network 109, wireless network 111, service provider network 113, etc.). According to one embodiment, the services may be part of managed services supplied by a service provider (e.g., a wireless communication company) as a hosted or subscription-based service (e.g., Video on Demand (VoD), pay-per-view, on-demand music streaming) to a user of computing device 115 through service provider network 113.

As shown, data center 130 may be connected to data center 120 through service provider network 113. Under the scenario of FIG. 1, data centers 120 and 130 belong to the administrative domain of a single service provider even though the data centers may be geographically separated. Data center 130 may communicate with data center 120 via service provider network 113 to provide information associated with intelligent load balancing. Such information may include, for example, the operational status of data center 130, duplication delay, and data processing capacity.

In certain embodiments, duplication delay refers to the replication delay between the data centers (e.g., centers 120 and 130). In one embodiment, replication delay may be a measure of the delay associated with replicating databases between data center 120 and data center 130. While specific reference will be made thereto, it is contemplated that replication delay may also refer to the delay associated with disk storage replication (e.g., disk mirroring), distributed memory replication and other forms of storage replication. Disk storage may include Redundant Arrays of Independent Disks (RAID arrays), solid-state disk drives and other high-access storage systems. Operational status may, for example, indicate whether data center 130 is available to receive service requests and may be represented by an UP or DOWN status value stored in a computer's program memory. The operational status may also indicate that data center 130 is transitioning from an UP to a DOWN state, in which case the status may be represented by a TRANSITION status value.

As shown, data center 120 may be connected to or include site selector 121. In one embodiment, site selector 121 refers to a computing system that can provide traffic routing information to system 100 with respect to services supported by data centers 120 and 130. It is contemplated that site selector 121 may embody name resolution and/or routing services using various network addressing schemes. As further shown, site selector 121 may be connected to or include status database 123 which stores status information received from data center 130. In one embodiment, site selector 121 populates status database 123 based on periodic Hypertext Transfer Protocol (HTTP) keep-alive messages exchanged between data centers 120 and 130.

It is contemplated that system 100 may include additional data centers (not shown), which may be a part of or connected to service provider network 113. Like data center 130, each of the additional data centers may also include or be connected to load balancing platform 101 or be locally served by their own load balancing platform (not shown). As such, site selector 121 may access status database 123 to acquire information concerning the status of these other data centers; in this manner, load balancing platform 101 can then determine whether traffic (e.g., service requests) can be routed to the newly designated data center.

Data centers, such as those described herein, play a critical role as part of the business subsystems of a service provider. For example, the provisioning of services, as well as handling customer service issues, is typically processed through the use of data centers. Hence, delays introduced by these centers directly affect the user experience if, for example, information requested by the user is not timely provided from the data center accessed by the user. Consequently, workloads need to be balanced across the data centers. However, traditional load balancing approaches have not factored in all key parameters that contribute to the delay.

To address this issue, the system 100 of FIG. 1 introduces the capability to modify the routing information for data center 120 using load balancing platform 101 at, for example, remote data center 130. It is contemplated that load balancing platform 101 may simply have connectivity to the data centers 120 and 130 directly via service provider network 113. By way of example, load balancing platform 101 may determine whether a Video on Demand (VoD) request from a subscriber can be serviced at data center 130, instead of data center 120 without compromising the latency experienced by the subscriber. Thus, platform 101 enables service providers to maintain satisfactory response times even as the workload is transferred from data center 120 to the remote data center 130, which may be geographically proximate to data center 120.

In some embodiments, load balancing platform 101, mobile devices 103, computing device 115 and other elements of system 100 may be configured to communicate via service provider network 113. According to certain embodiments, one or more networks, such as data network 107, telephony network 109, and/or wireless network 111, may interact with service provider network 113. The networks 107-113 may be any suitable wireline and/or wireless network, and be managed by one or more service providers. For example, data network 107 may be any local area network (LAN), metropolitan area network (MAN), wide area network (WAN), the Internet, or any other suitable packet-switched network, such as a commercially owned, proprietary packet-switched network, such as a proprietary cable or fiber-optic network. For example, computing device 115 may be any suitable computing device, such as a VoIP phone, skinny client control protocol (SCCP) phone, session initiation protocol (SIP) phone, IP phone, personal computer, softphone, workstation, terminal, server, etc. The telephony network 109 may include a circuit-switched network, such as the public switched telephone network (PSTN), an integrated services digital network (ISDN), a private branch exchange (PBX), or other like network. For instance, voice station 117 may be any suitable plain old telephone service (POTS) device, facsimile machine, etc. Meanwhile, the wireless network 111 may employ various technologies including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like.

Although depicted as separate entities, the networks 107-113 may be completely or partially contained within one another, or may embody one or more of the aforementioned infrastructures. For instance, service provider network 113 may embody circuit-switched and/or packet-switched networks that include facilities to provide for transport of circuit-switched and/or packet-based communications. It is further contemplated that the networks 107-113 may include components and facilities to provide for signaling and/or bearer communications between the various components or facilities of system 100. In this manner, the networks 107-113 may embody or include portions of a signaling system 7 (SS7) network, Internet protocol multimedia subsystem (IMS), or other suitable infrastructure to support control and signaling functions.

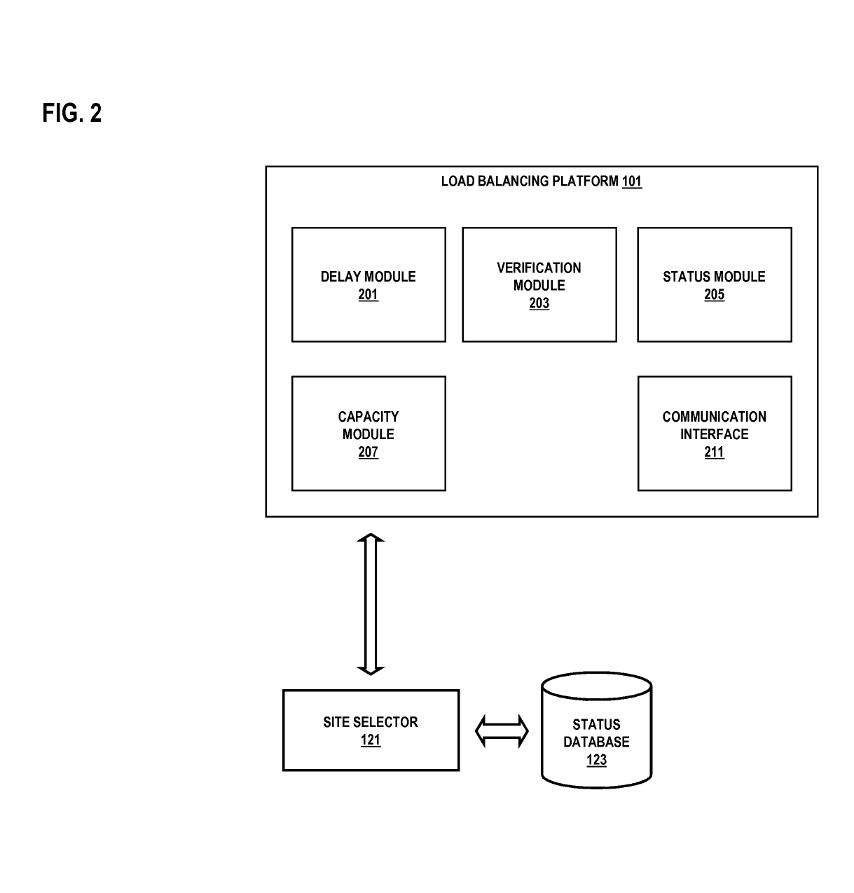

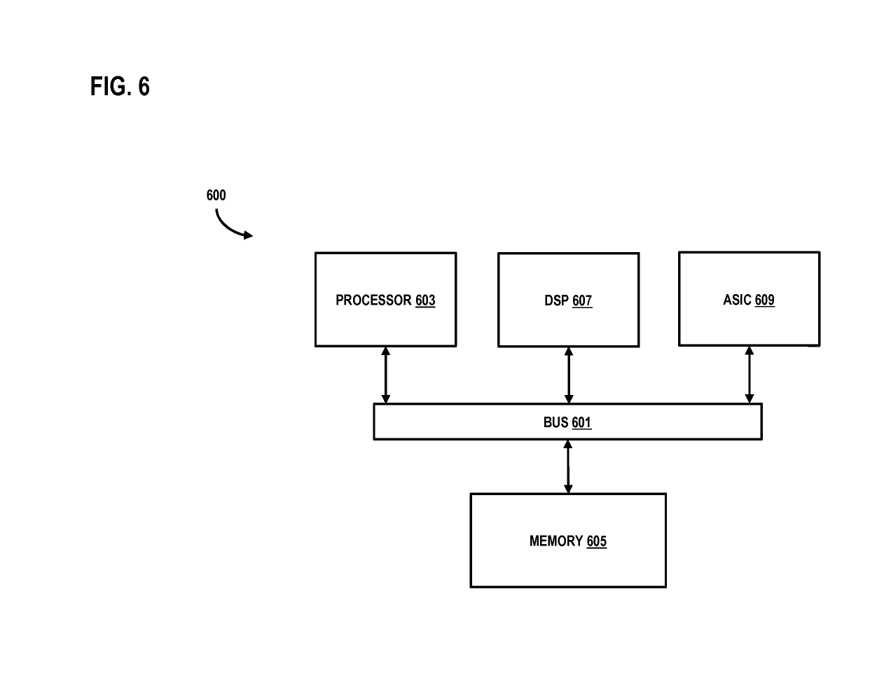

FIG. 2 is a diagram of the components of load balancing platform 101, according to an embodiment. Platform 101 may comprise computing hardware (such as described with respect to FIG. 6), as well as include one or more components configured to execute the processes described herein for providing load balancing of system 100. It is contemplated that the functions of these components may be combined in one or more components or performed by other components of equivalent functionality. In one implementation, load balancing platform 101 includes a delay module 201, verification module 203, status module 205, capacity module 207, and communication interface 211.

According to one embodiment, load balancing platform 101 may include a delay module 201 for determining or obtaining the amount of time taken to duplicate content (e.g., multimedia streaming data) between data centers 120 and 130. Delay may be incurred due to latencies associated with data processing speeds at the data centers and transmitting the content to be duplicated over congested or low speed Wide Area Network (WAN) communication links. Additional latencies may be incurred due to retransmissions of the data and particular duplication protocols employed by the service provider.

In one embodiment, delay module 201 obtains the replication delay between databases in data centers 120 and 130, respectively. Although specific reference will be made thereto, it is contemplated that delay module 201 can obtain delays associated with replicating data between other forms of storage systems. For example, delay module 201 may obtain the delay associated with disk, file or distributed memory replication. Such delays may also be referred to herein as latency and measure the duration between when an application modifies data on a local database (i.e., a database located in data center 130) and when the changes are duplicated to a remote database (i.e., a database located in data center 120). After obtaining the delay, delay module 201 may store the value for later retrieval and communication to other modules of platform 101.

According to one embodiment, load balancing platform 101 may include a verification module 203 for determining whether a duration for which a particular duplication delay obtained by delay module 201 has exceeded a threshold delay value. For example, verification module 203 may determine whether the duplication delay has exceeded a threshold delay value for a threshold duration value (e.g., 120 seconds). Similarly, verification module 203 may be used to determine whether the duplication delay has not exceeded the threshold delay value for the threshold duration value. The threshold duration values in each case may be identical or different.

In one embodiment, verification module 203 sets the value of a variable in a computer's program memory to the current time whenever the delay obtained by delay module 201 rises above or falls below the threshold delay value. Subsequently, the value of the variable is compared to the current time to obtain the duration for which the duplication delay has remained above or below the threshold delay value. Verification module 203 determines that the delay has been verified if the duration exceeds the threshold duration value (e.g., 120 seconds).

According to one embodiment, load balancing platform 101 may include a status module 205 that stores the status of data center 130. In certain embodiments, “status” refers to the availability of data center 130. For example, status module 205 may indicate data center 130 as being in UP (available), DOWN (unavailable) or TRANSITION (in between available and unavailable) state. The UP state indicates that data center 130 is available to provide a service; the DOWN state indicates data center 130 is not available to provide the service; the TRANSITION state indicates that the status of data center 130 is about to change from UP to DOWN state. In one embodiment, status module 205 may store the state information in a computer's program memory such that it is accessible to other modules of load balancing platform 101. In another embodiment, an UP/DOWN state may also indicate whether data center 130 has sufficient number of servers to process a particular service request.

According to one embodiment, load balancing platform 101 may include a capacity module 207 for determining whether the available processing capacity of data center 120 is sufficient to provide a service to a subscriber. In certain embodiments, processing capacity may refer to computing resources such as computation (e.g., number of Central Processing Units (CPUs) or CPU cores), storage (e.g., number of gigabytes of memory) and communication bandwidth (e.g., number of megabytes per second). In one embodiment, processing capacity may refer to the number of servers. For instance, capacity module 207 may determine whether the number of servers available at data center 120 is greater than a threshold minimum number of servers. The threshold minimum number of servers may be stored in a computer's program memory as the value of a variable. Although specific reference will be made thereto, it is contemplated that other measures of processing and storage capacity, including various logical pools of computing resources, may also be used by capacity module 207. Further, it is contemplated that server may refer to any computerized process that shares a resource to one or more client processes.

The load balancing platform 101 may further include a communication interface 211 to communicate with other components of platform 101, data center 120, and other components of system 100. Communication interface 211 may include multiple means of communication. For example, communication interface 211 may be able to communicate over a message queuing system such as short message service (SMS), multimedia messaging service (MMS), internet protocol, instant messaging, voice sessions (e.g., via a phone network), email, or other types of communication. Additionally, communication interface 211 may include a web portal accessible by, for example, data center 120, computing device 115 and the like.

It is contemplated that to prevent the unauthorized access, load balancing platform 101 may include an authentication identifier when transmitting signals to data center 120. For instance, control messages may be encrypted, either symmetrically or asymmetrically, such that a hash value, for instance, can be utilized to authenticate received control signals, as well as ensure that those signals have not been impermissibly alerted in transit. As such, communications between data center 120 and load balancing platform 101 may include various identifiers, keys, random numbers, random handshakes, digital signatures, and the like.

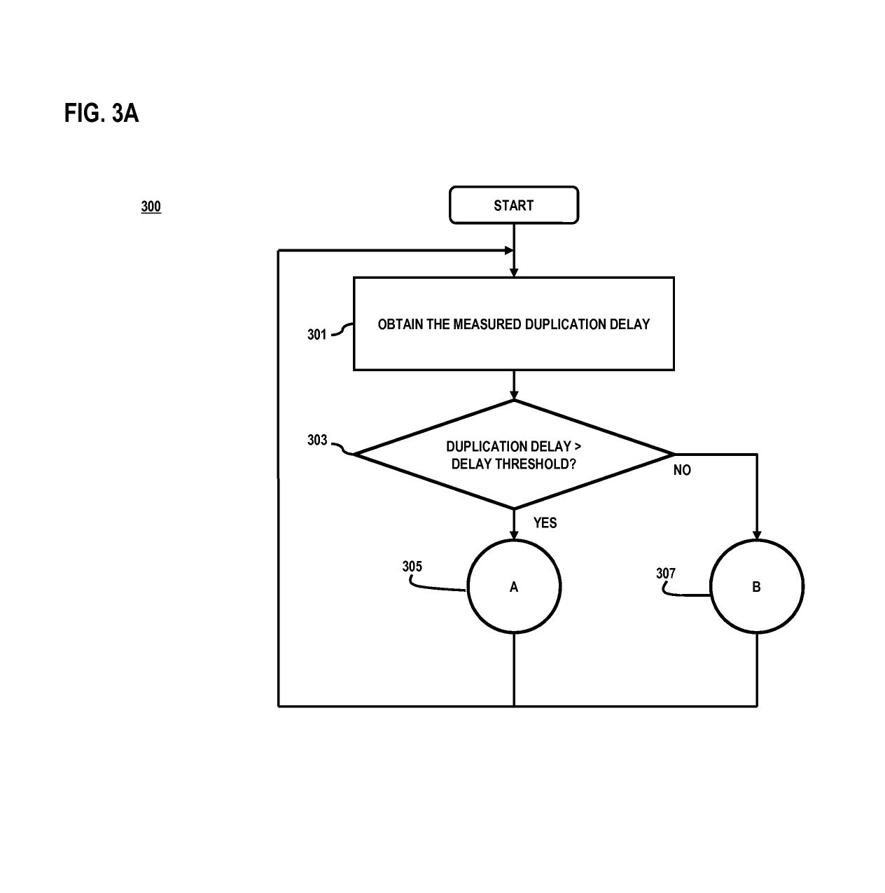

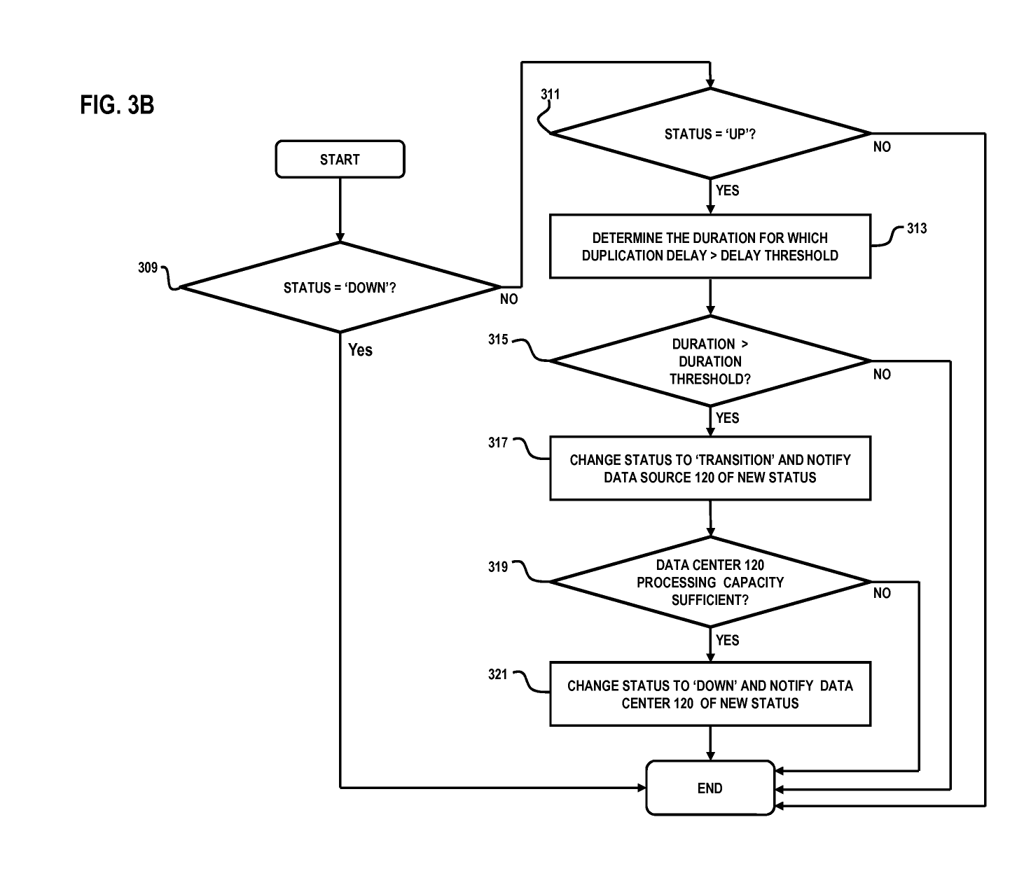

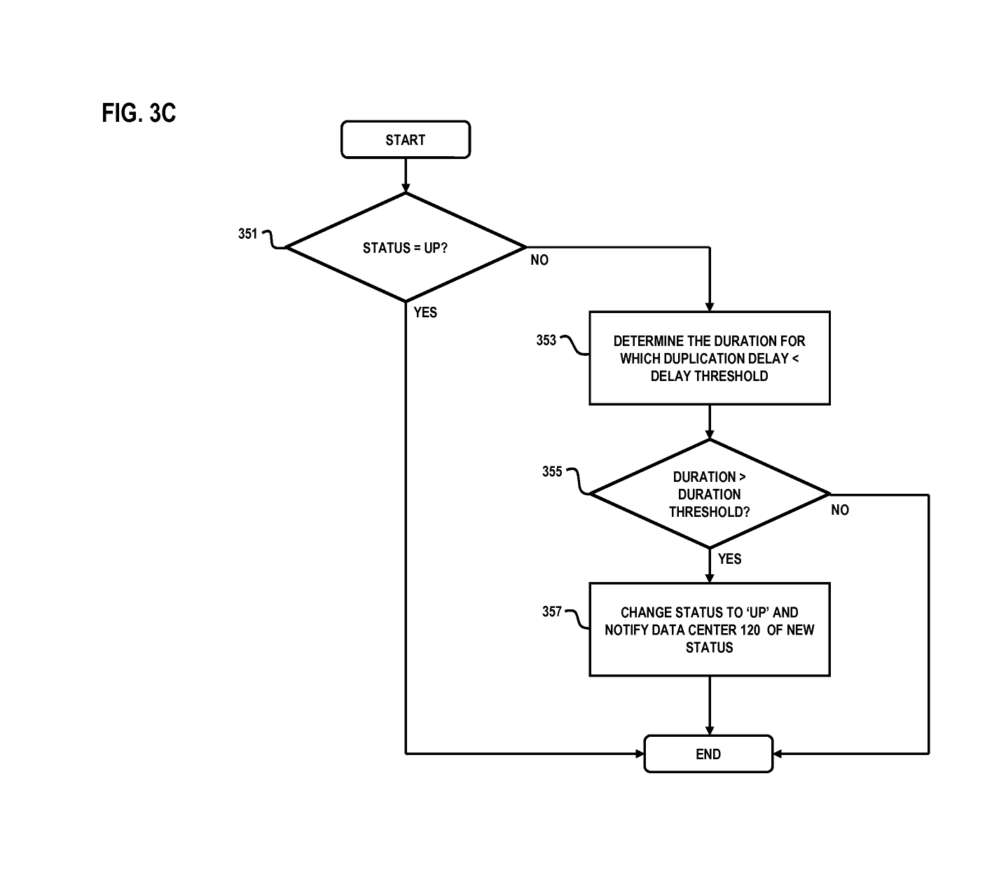

FIGS. 3A, 3B and 3C are flowcharts of a process for providing load balancing, according to an embodiment. For illustrative purpose, process 300 is described with respect to the system of FIG. 1. It is noted that the steps of process 300 may be performed in any suitable order, as well as combined or separated in any suitable manner. By way of example, a subscriber at computing device 115 may request a video streaming service from the service provider while process 300 is iteratively executing within a single computational thread on load balancing platform 101. Process 300 may cause the video streaming service to be provided by data center 120 or 130 based on the duplication delay between the data centers. For example, the subscriber may be request the video streaming service when the duplication delay is below a threshold value in which case platform 101 transparently causes the service request to be forwarded to data center 130.

In step 301, the duplication delay between data centers 120 and 130 is obtained. Duplication delay may include latency associated with communication between and within data centers 120 and 130. It may also include delays associated with copying and processing data as it is duplicated between data centers 120 and 130. In one embodiment, duplication delay is the delay to replicate data between databases in data centers 120 and 130, respectively. This delay may be measured by database management systems maintained by data centers 120 and 130.

In step 303, load balancing platform 101 determines whether the duplication delay is greater than a threshold delay value. In one embodiment, the threshold delay value may be configured as the value of a variable stored in the memory of a computing system executing process 300. The value may be configured so as to make platform 101 more or less sensitive to duplication delay: a large value makes platform 101 more tolerant of duplication delay and, therefore, allows more load balancing. If the duplication delay is greater than the threshold delay value, process 300 proceeds to step 305; if not, it proceeds to step 307.

As shown, step 305 corresponds to performing the steps in logic block A and step 307 corresponds to performing the steps in logic block B. The process returns to step 301 after the steps in the selected logic block have been executed. Logic blocks A and B are next described with respect to FIGS. 3B and 3C, respectively.

FIG. 3B is a flowchart for a process in logic block A, as shown in FIG. 3A. In step 309, load balancing platform 101 determines the current status of data center 130. If the current status is DOWN, process 300 returns to step 301. If not, the process continues to step 311. In one embodiment, the current status of data center 130 is the value of a variable stored in the memory of a computing system executing process 300. To determine whether the current status of data center 130 is DOWN, process 300 compares the value of the stored variable to a predefined static value for the DOWN state. Next, in step 311, platform 101 determines if the current status of data center 130 is UP. If it is, process 300 continues to step 313; if not, process 300 returns to step 301.

In step 313, load balancing platform 101 determines the duration, including successively earlier iterations of process 300, for which the duplication delay has exceeded the threshold delay value. For instance, step 313 may involve obtaining the difference between the current time and the time of the earliest successive iteration at which the duplication delay exceeded the threshold delay value. In one embodiment, the time of the earliest successive iteration of process 300 for which the duplication delay exceeded the threshold delay value may be stored in the memory of a computer system executing process 300. To determine the duration for which the duplication delay has exceeded the threshold delay value, the stored value may be subtracted from the current time.

Next, in step 315, load balancing platform 101 determines whether the duration determined in step 313 is greater than a threshold duration value. In one embodiment, the threshold duration value may be configured as the value of a variable stored in the memory of a computing system executing process 300. The value of the duration threshold may be configured so as to make platform 101 more or less sensitive to variations in duplication delay: a large threshold value requires the duplication delay to exceed the threshold delay value for a longer time than a smaller threshold value. If platform 101 determines that the duration is greater than the threshold duration value, process 300 continues to step 317. If not, process 300 returns to step 301.

In step 317, load balancing platform 101 changes the status of data center 130 to TRANSITION and notifies data center 120 of the new status. In one embodiment, platform 101 changes the status of data center 130 by changing the value of the variable storing the current status of data center 130 and sending the new status to data center 120 via periodic HTTP keep-alive message exchanged between the data centers.

In step 319, load balancing platform 101 determines whether data center 120 has processing capacity sufficient to provide the video streaming service to the subscriber. In certain embodiments, processing capacity may refer to computing resources such as computation (e.g., number of Central Processing Units (CPUs) or CPU cores), storage (e.g., number of gigabytes of memory) and communication bandwidth (e.g., number of megabytes per second). For example, processing capacity may refer to the number of servers in data center 120 that are not being currently used. In one embodiment, capacity module 207 may determine whether the number of servers available at data center 120 is greater than a threshold minimum server number value. Platform 101 may obtain the number of servers available at data center 120 via periodic HTTP keep-alive messages exchanged between the data centers. The threshold minimum server number value may be configured as the value of a variable stored in the memory of a computing system executing process 300.

If data center 120 has sufficient processing capacity, process 300 continues to step 321. In step 321, load balancing platform 101 changes the status of data center 130 to DOWN and notifies data center 120 of the new status. If data center 120 does not have sufficient processing capacity, process 300 returns to step 301.

FIG. 3C is a flowchart for a process in logic block B, as shown in FIG. 3A. In step 351, load balancing platform 101 determines whether the current status of data center 130 is UP. If so, process 300 returns to step 301. If not, process 300 continues to step 353.

In step 353, load balancing platform 101 determines the duration, including successively earlier iterations of process 300, for which the replication delay has been smaller than the threshold delay value. For instance, step 353 may involve obtaining the difference between the current time and the time of the earliest iteration at which the duplication delay was smaller than the threshold delay value. In one embodiment, the time of the earliest successive iteration at which the duplication delay was smaller than the threshold delay value may be stored in the memory of a computer system executing process 300. To determine the duration for which the duplication delay has been smaller than the threshold delay value, the stored value may be subtracted from the current time.

Next, in step 355, load balancing platform 101 determines whether the duration obtained in step 353 is greater than a threshold duration value. If not, process 300 returns to step 301. If, however, the duration is greater than the threshold duration, process 300 advances to step 357 where platform 101 changes the status of data center 130 to UP and informs data center 120 of the new status.

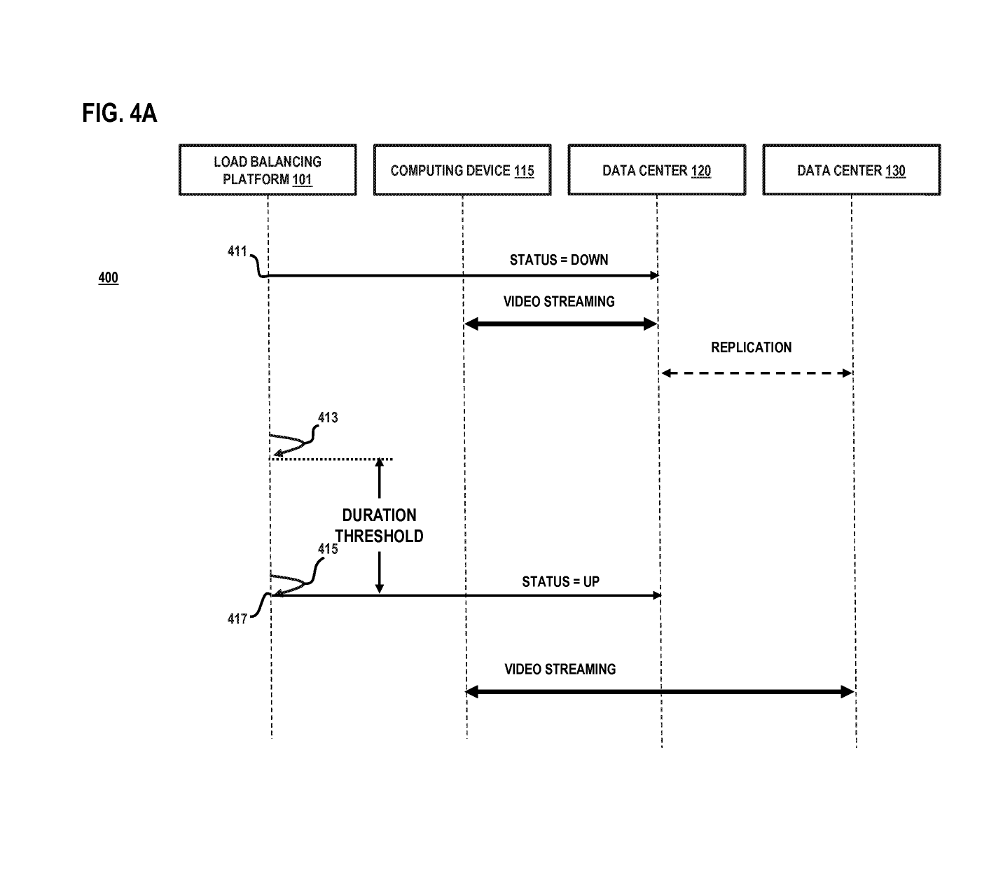

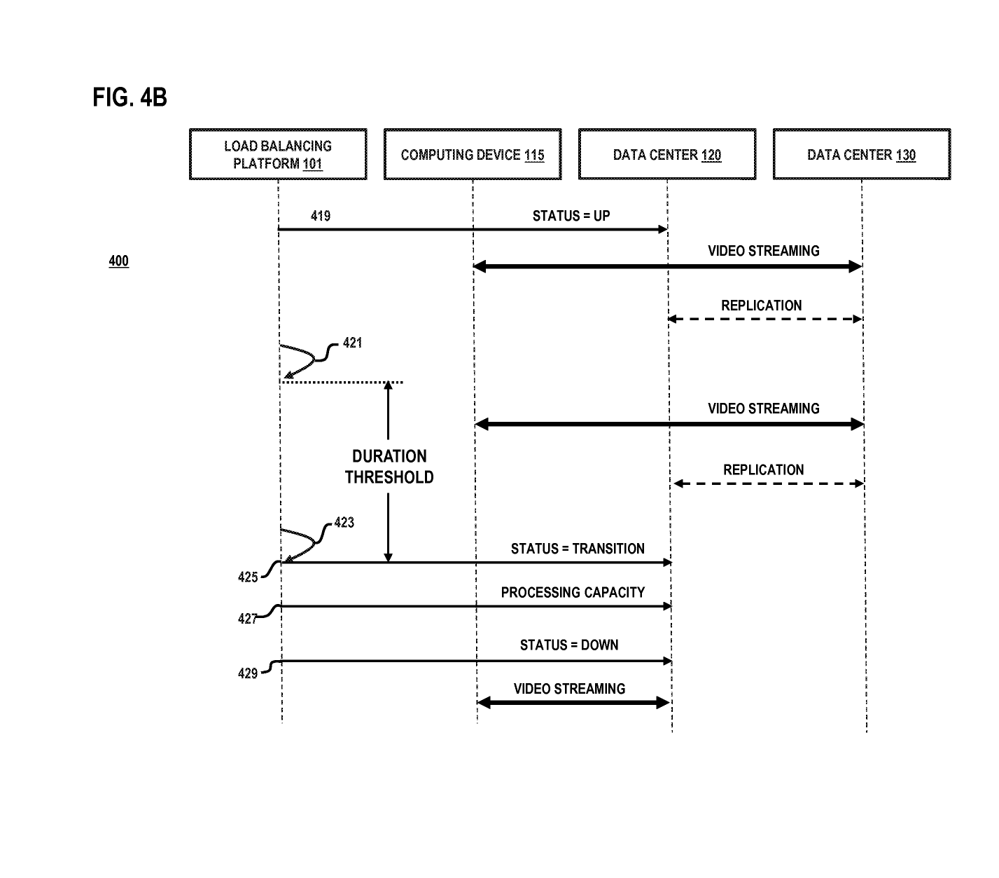

FIGS. 4A and 4B are ladder diagrams of a process for load balancing, according to an embodiment. For illustrative purpose, process 400 is described with respect to the system of FIG. 1, whereby a subscriber at computing device 115 requests a particular service and load balancing platform 101 causes the service to be provided from either data center 120 or 130 depending on the duplication delay. In addition to the steps of process 400, FIGS. 4A and 4B also illustrate the interaction between computing device 115 and data centers 120 and 130. It is noted that the steps of process 400 may be performed in any suitable order, as well as combined or separated in any suitable manner. In this example, computing device 115 may be any device (e.g., smart TV, laptop, personal computer, mobile phone, PDA, workstation) accessing a video streaming service provided by the service provider.

In step 411, load balancing platform 101 notifies data center 120 that data center 130 is in DOWN state. As a result of receiving the notification, data center 120 begins providing the requested video streaming service to computing device 115. Thus, as shown, computing device 115 accesses the desired video streaming service at data center 120. It is contemplated that the subscriber's request may, in certain embodiments, be transmitted along with subscriber authentication and authorization information. Thus, the data center receiving the request may perform authentication and authorization functions before allowing the subscriber to access the requested service.

As shown, data duplication occurs between data centers 120 and 130 subsequently. Although shown as a single event, the duplication may be part of an ongoing duplication or mirroring process and may occur repeatedly at various time intervals depending on the specific duplication mechanism employed by the service provider. Further, the timing of the duplication may be independent with respect to the timing of the events of process 400. In one embodiment, the duplication may be a synchronous replication between mirrored databases in data centers 120 and 130.

In step 413, load balancing platform 101 obtains the duplication delay and determines that the delay satisfies a threshold delay value. At this point, platform 101 begins monitoring the time elapsed since step 413. In one embodiment, the duplication delay may be a replication delay associated with replicating data between data centers 120 and 130.

In step 415, platform 101 determines that the time elapsed since step 413 is greater than a threshold duration value. Thus, in step 417, platform 101 notifies data center 120 that the status of data center 130 is UP. Upon receiving the notification, data center 120 modifies the routing information of system 100 so as to cause computing device 115 to access the video streaming service at data center 130. Thus, as shown, computing device 115 begins accessing the video streaming service at data center 130 instead of data center 120. It is contemplated that the shift from data center 120 to data center 130 will be transparent to computing device 115 because the accessed content is duplicated between the data centers.

In step 419, load balancing platform 101 sends a message to data center 120 indicating that data center 130 is in UP state. As shown, computing device 115 continues to access the video streaming service at data center 130. Subsequently (or concurrently), data duplication occurs between data centers 120 and 130. In step 421, platform 101 obtains the duplication delay and determines that it no longer satisfies the threshold delay value. At this point, platform 101 begins monitoring the duration of the period for which the duplication delay does not satisfy the threshold delay value.

In step 423, platform 101 determines that the duration for which the duplication delay does not satisfy the threshold delay value is greater than a threshold duration value. Thus, in step 425, platform 101 sends a message to data center 120 indicating that data center 130 is in TRANSITION state. As shown, computing device 115 at this time continues to request and obtain access to the video streaming service at data center 130.

In step 427, load balancing platform 101 receives from data center 120 its available processing capacity. In one embodiment, platform 101 may query site selector 121 to obtain the number of available servers at data center 120. It is contemplated that platform 101 may then determine whether the number of available servers are sufficient to provide the video streaming service being accessed by the subscriber from data center 130. In step 429, platform 101 notifies data center 120 that the status of data center 130 is DOWN.

Data center 120 receives the message and causes the routing information of system 100 to be modified such that the video streaming service is provided by data center 120. Therefore, as shown, computing device 115 subsequently accesses the video streaming service at data center 120 instead of data center 130.

The processes described herein for load balancing may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

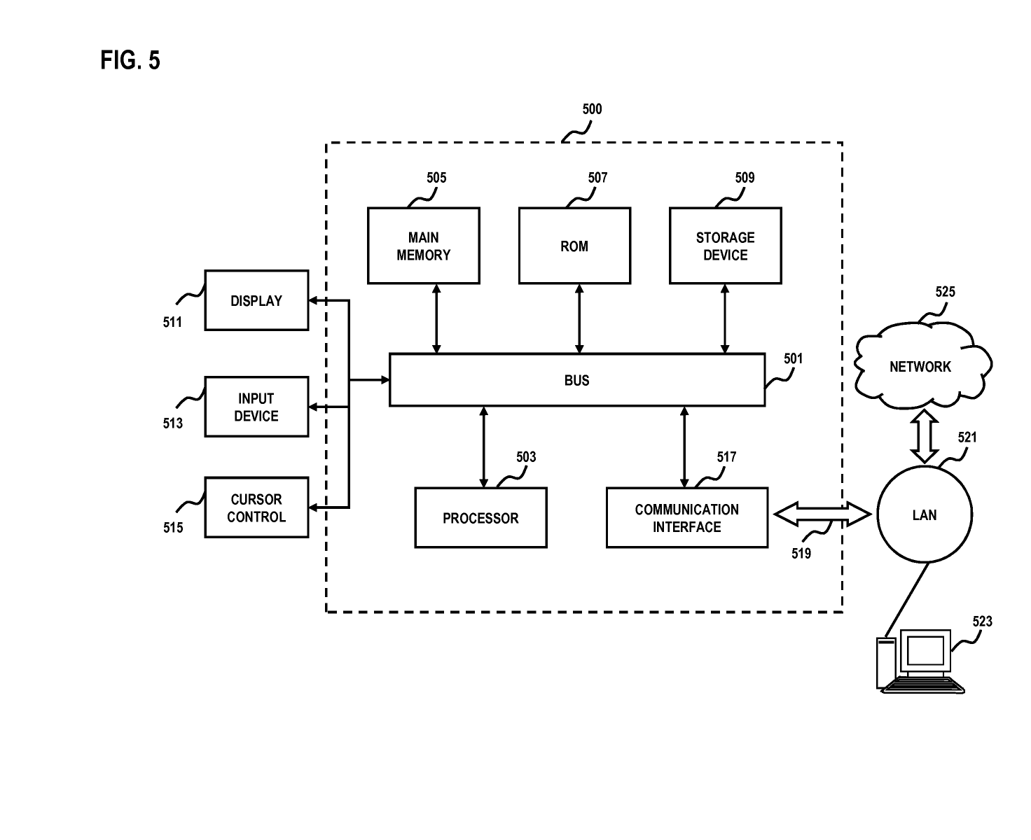

FIG. 5 is a diagram of a computer system that can be used to implement various exemplary embodiments. The computer system 500 includes a bus 501 or other communication mechanism for communicating information and one or more processors (of which one is shown) 503 coupled to the bus 501 for processing information. The computer system 500 also includes main memory 505, such as a random access memory (RAM) or other dynamic storage device, coupled to the bus 501 for storing information and instructions to be executed by the processor 503. Main memory 505 can also be used for storing temporary variables or other intermediate information during execution of instructions by the processor 503. The computer system 500 may further include a read only memory (ROM) 507 or other static storage device coupled to the bus 501 for storing static information and instructions for the processor 503. A storage device 509, such as a magnetic disk, flash storage, or optical disk, is coupled to the bus 501 for persistently storing information and instructions.

The computer system 500 may be coupled via the bus 501 to a display 511, such as a cathode ray tube (CRT), liquid crystal display, active matrix display, or plasma display, for displaying information to a computer user. Additional output mechanisms may include haptics, audio, video, etc. An input device 513, such as a keyboard including alphanumeric and other keys, is coupled to the bus 501 for communicating information and command selections to the processor 503. Another type of user input device is a cursor control 515, such as a mouse, a trackball, touch screen, or cursor direction keys, for communicating direction information and command selections to the processor 503 and for adjusting cursor movement on the display 511.

According to an embodiment of the invention, the processes described herein are performed by the computer system 500, in response to the processor 503 executing an arrangement of instructions contained in main memory 505. Such instructions can be read into main memory 505 from another computer-readable medium, such as the storage device 509. Execution of the arrangement of instructions contained in main memory 505 causes the processor 503 to perform the process steps described herein. One or more processors in a multi-processing arrangement may also be employed to execute the instructions contained in main memory 505. In alternative embodiments, hard-wired circuitry may be used in place of or in combination with software instructions to implement the embodiment of the invention. Thus, embodiments of the invention are not limited to any specific combination of hardware circuitry and software.

The computer system 500 also includes a communication interface 517 coupled to bus 501. The communication interface 517 provides a two-way data communication coupling to a network link 519 connected to a local network 521. For example, the communication interface 517 may be a digital subscriber line (DSL) card or modem, an integrated services digital network (ISDN) card, a cable modem, a telephone modem, or any other communication interface to provide a data communication connection to a corresponding type of communication line. As another example, communication interface 517 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 517 sends and receives electrical, electromagnetic, or optical signals that carry digital data streams representing various types of information. Further, the communication interface 517 can include peripheral interface devices, such as a Universal Serial Bus (USB) interface, a PCMCIA (Personal Computer Memory Card International Association) interface, etc. Although a single communication interface 517 is depicted in FIG. 5, multiple communication interfaces can also be employed.

The network link 519 typically provides data communication through one or more networks to other data devices. For example, the network link 519 may provide a connection through local network 521 to a host computer 523, which has connectivity to a network 525 (e.g. a wide area network (WAN) or the global packet data communication network now commonly referred to as the “Internet”) or to data equipment operated by a service provider. The local network 521 and the network 525 both use electrical, electromagnetic, or optical signals to convey information and instructions. The signals through the various networks and the signals on the network link 519 and through the communication interface 517, which communicate digital data with the computer system 500, are exemplary forms of carrier waves bearing the information and instructions.

The computer system 500 can send messages and receive data, including program code, through the network(s), the network link 519, and the communication interface 517. In the Internet example, a server (not shown) might transmit requested code belonging to an application program for implementing an embodiment of the invention through the network 525, the local network 521 and the communication interface 517. The processor 503 may execute the transmitted code while being received and/or store the code in the storage device 509, or other non-volatile storage for later execution. In this manner, the computer system 500 may obtain application code in the form of a carrier wave.

The term “computer-readable medium” as used herein refers to any medium that participates in providing instructions to the processor 503 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 509. Volatile media include dynamic memory, such as main memory 505. Transmission media include coaxial cables, copper wire and fiber optics, including the wires that comprise the bus 501. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIG. 6 illustrates a chip set or chip 600 upon which an embodiment of the invention may be implemented. Chip set 600 is programmed to enable intelligent load balancing as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of enabling intelligent load balancing.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to enable intelligent load balancing. The memory 605 also stores the data associated with or generated by the execution of the inventive steps.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
monitoring a replication delay associated with a replication of data between a first data center and a second data center; and
determining to halt access to the data at the second data center if the replication delay satisfies a threshold delay value.

2. The method of claim 1, wherein the data includes a video stream or an audio stream, the method further comprising:
setting an operational status value based on the satisfaction of the threshold delay value; and
determining to allow access to the data at the second data center if the operational status value indicates that the replication delay does not satisfy the threshold delay value.

3. The method of claim 2, further comprising:
notifying the first data center of the replication delay.

4. The method of claim 3, further comprising:
selectively notifying the first data center of the determination to halt access to the data when the replication delay has satisfied the threshold delay value for a predetermined duration.

5. The method of claim 3, further comprising:
determining to allow access to the data at the first data center if the replication delay satisfies the threshold delay value.

6. The method of claim 5, wherein access to the data at the second data center is halted if the first data center has access to sufficient unused processing capacity.

7. The method of claim 6, wherein the first data center has access to sufficient processing capacity if the first data center has access to greater than a minimum number of unused servers.

8. A non-transitory computer-readable medium embodying a computer-readable program adapted to execute the method of claim 1.

9. An apparatus comprising:
at least one processor; and
at least one memory including computer program code for one or more programs,
the at least one memory and the computer program code configured to, with the at least one processor, cause the apparatus to perform at least the following,
monitor a replication delay associated with a replication of data between a first data center and a second data center, and
determine to halt access to the data at a second data center if the replication delay satisfies a threshold delay value.

10. The apparatus according to claim 9, wherein the data includes a video stream or an audio stream, and wherein the apparatus is further caused to:
set an operational status value based on the satisfaction of the threshold delay value; and
determine to allow access to the data at the second data center if the operational status value indicates that the replication delay does not satisfy the threshold delay value.

11. The apparatus according to claim 10, wherein the apparatus is further caused to:
notify a first data center of the replication delay.

12. The apparatus of claim 11, wherein the apparatus is further caused to:
selectively notify the first data center of the determination to halt access to the data when the replication delay has satisfied the threshold delay value for a predetermined duration.

13. The apparatus of claim 11, wherein the apparatus is further caused to:
determine to allow access to the data at the first data center if the replication delay satisfies the threshold delay value.

14. The apparatus of claim 13, wherein access to the data at the second data center is halted if the first data center has access to sufficient unused processing capacity.

15. The apparatus of claim 14, wherein the first data center has access to sufficient processing capacity if the first data center has access to greater than a minimum number of unused servers.

16. A system comprising:
a load balancing platform configured to monitor a replication delay associated with a replication of data between a first data center and a second data center,
wherein the load balancing platform is further configured to determine to halt access to the data at a second data center if the replication delay satisfies a threshold delay value.

17. The system according to claim 16, wherein the data includes a video stream or an audio stream, and wherein the system is further configured to:
set an operational status value based on the satisfaction of the threshold delay value; and
determine to allow access to the data at the second data center if the operational status value indicates that the replication delay does not satisfy the threshold delay value.

18. The system according to claim 17, wherein the load balancing platform is further configured to notify a first data center of the replication delay.

19. The system of claim 18, wherein the load balancing platform is further configured to selectively notify the first data center of the determination to halt access to the data when the replication delay has satisfied the threshold delay value for a predetermined duration.

20. The system of claim 18, wherein the load balancing platform is further configured to determine to allow access to the data at the first data center if the replication delay satisfies the threshold delay value.

21. The system of claim 20, wherein access to the data at the second data center is halted if the first data center has access to sufficient unused processing capacity.

22. The system of claim 21, wherein the first data center has access to sufficient processing capacity if the first data center has access to greater than a minimum number of unused servers.
